(19) United States
(12) Patent Application Publication
(10) Pub. No.: US 2014/0356506 A1
(43) Pub. Date: Dec. 4, 2014

(54) PROCESS FOR MODIFICATION OF BRAN FROM GRAINS AND FOOD USAGES THEREOF

(71) Applicant: Kellogg Company, Battle Creek, MI (US)

(72) Inventor: Monjur Hossen, Battle Creek, MI (US)

(21) Appl. No.: 14/294,859

(22) Filed: Jun. 3, 2014

Related U.S. Application Data
(60) Provisional application No. 61/830,331, filed on Jun. 3, 2013.

(51) Int. Cl. A23L 1/10

(52) U.S. Cl. CPC A23L 1/1016; A23L 1/1033; A23L 1/1041
USPC 426/549; 426/509; 426/463; 426/622; 426/590

(57) ABSTRACT

Some embodiments comprise a process for forming a modified bran product for use in a variety of food products including beverages, ready to eat cereals, cereal products, granola type products, health bars, baked goods and confections. An exemplary process comprises first cooking the bran at high temperatures of from 250 to 290° Fahrenheit for 30 seconds to 4 minutes to form a cooked bran slurry. The cooked bran slurry is then subjected to an aqueous micro-grinding step to form a cooked slurry having a mean particle size of 150 microns or less. Alternatively, the cooked bran slurry is first dried and then later subjected to grinding or pulverization to form a cooked bran powder having a mean particle size of 150 microns or less.

### RELATED APPLICATIONS

This application claims the benefit of U.S. provisional patent application Ser. No. 61/830,331 filed Jun. 3, 2013, the entire contents of which are hereby incorporated in full in this application.

### TECHNICAL FIELD

Some embodiments relate generally to bran from grains and more particularly to a process for making bran more palatable and useful in a variety of food forms.

### BACKGROUND

Health advocates have long suggested that the modern diet is low in fiber and therefore have encouraged consumers to increase their intake of dietary fiber. Dietary fiber is found in both soluble forms and insoluble forms. Both forms of fiber find use in consumer food products. Often soluble fiber is easier to incorporate into a given food form because of its solubility. Bran is an insoluble form of fiber and thus is more difficult to incorporate into foods. In the past, attempts to functionalize bran have included the pulverization of dry bran into smaller particles of 5 to 100 microns. This has not resulted in a palatable product and thus there has not been widespread use of bran alone in food products. In general, bran is incorporated into food products by using whole-grains in the food product. Whole-grains include the outer bran layer, the germ, and endosperm portions of the grain. Suitable brans can be found on wheat, oat, corn, rice, rye, and barley. Some of these seed grains also include an outer layer called a husk layer that is outside the bran layer, which is typically removed during harvesting of the grains.

An unmet needs remains for a process for providing a palatable bran product from a variety of grains wherein the bran can be readily incorporated into food products. Preferably the bran has a smooth texture with low to no gritty flavor and thus will not detract from the food into which it is incorporated. Preferably, the improved texture allows the bran to be used in foods and beverages at levels of from 1 to 50% by weight based on the total food or beverage weight, more preferably from 1 to 25% by weight.

### SUMMARY

Without limitation to only those embodiments which may be expressly discussed herein, and without waiving or disclaiming any embodiments or subject matter, some embodiments provide a process for modifying bran that results in a palatable product that can be used in a variety of food and other forms, including but not limited to, beverages, baked goods, ready-to-eat cereals, granola-type products, health bars, confectionaries, and other foods, as well as nutraceuticals and dietary supplements.

In some embodiments, the process comprises the steps of cooking a bran from a grain at a temperature of from 250° to 290° Fahrenheit for from 30 seconds to 4 minutes to form a cooked bran slurry (i.e., a semiliquid mixture), and then either grinding the cooked bran slurry to a mean particle size of 150 microns or less, or drying the cooked bran slurry and then pulverizing the dried cooked bran composition to a mean particle size of 150 microns or less.

These and other features and advantages of some embodiments will become more apparent to those skilled in the art from the drawings and detailed description below.

### BRIEF DESCRIPTION OF THE DRAWINGS

FIG. 1 is a graph of the particle size distribution of the modified bran product produced according to some nonlimiting embodiments after aqueous micro-grinding; and

FIG. 2 is a flow diagram of the modified bran process according to some embodiments.

### DETAILED DESCRIPTION

Health advocates have long encouraged the inclusion of increased levels of fiber in the human diet. Dietary fiber is divided into soluble fiber and insoluble fiber based on its solubility in water. Some embodiments are directed to insoluble fiber derived from the bran layer of grains. Some embodiments are directed to a process for modifying bran from grains in order to reduce the particle size and to make the size-reduced particles suitable for incorporation into a variety of food forms. In the past, bran has been subjected to milling to reduce the size of the bran with the hope that this would produce a palatable product. These attempts have not met with full success as the size-reduced bran particles still have a gritty and unacceptable texture and mouth feel to consumers. The bran produced according to some embodiments has a soft, pleasing texture and is more acceptable to consumers. The modified bran can be incorporated into baked goods, cereal products, granola type products, health bars, beverages, confectionaries and other food forms.

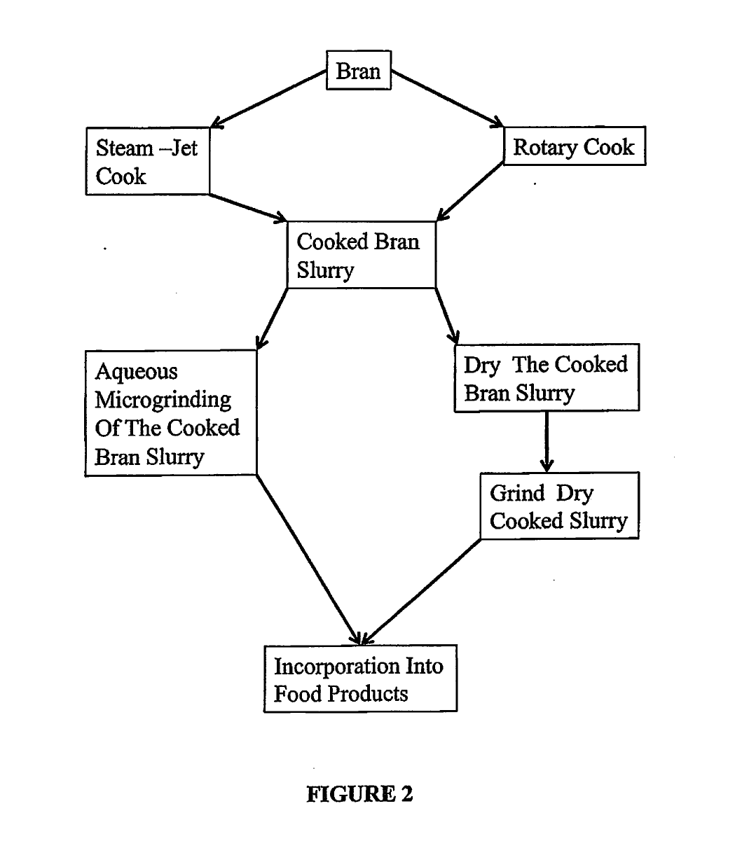

A flow diagram of a modified bran process according to some embodiments is shown in FIG. 2. The process begins with bran from a grain; any grains are suitable and may include, without limitation, wheat, oat, corn, rye, barley, rice bran, sorghum, teff, quinoa, hemp, and buckwheat. The starting bran component has been sieved to 100% through a US mesh size 14, which has openings of 1410 microns. The first step is cooking of the bran at high temperatures of from 250° Fahrenheit to 290° Fahrenheit (121° to 143° Celsius) for a total time period of between 30 seconds and 4 minutes inclusive, more preferably between 1 minute to 3 minutes inclusive. The initial moisture content of the bran is typically 15% or by weight based on total weight, and after the cooking step it ranges from 60 to 90% by weight, more preferably from 75 to 85% by weight. The cooking step can be accomplished in a standard rotary cooker or more preferably in a steam jet cooker as is known in the art. The cooking step allows for a palatable product and aids in the micro-grinding step. The cooked bran slurry is then preferably subjected to an aqueous micro-grinding step.

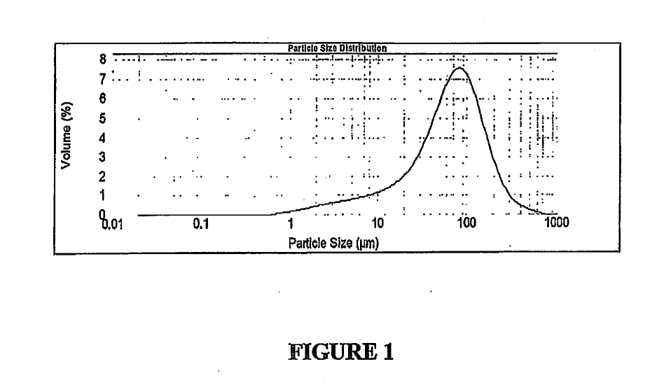

In some embodiments, the cooked bran slurry is taken to a moisture content of 60 to 90% by weight based on total weight, more preferably 75 to 85% by weight, and then subjected to an aqueous micro-grinding step. Micro-grinding can be accomplished in a single pass or after multiple passes. The cooked slurry is ground to a mean particle size of 150 microns or less, in some nonlimiting embodiments, 70 microns or less, preferably 65 microns or less. FIG. 1 shows a graph of the particle size distribution of a cooked slurry after micro-grinding according to some embodiments. The particle size was measured using a Malvern Laser Diffraction particle size analyzer as is known in the art. The data points are the average of at least three samples. The micro-ground cooked slurry can be used directly in food product manufacturing processes, as some nonlimiting examples, an Ultra High Temperature UHT beverage process, a dough-forming process, or other food processes as desired. In some embodiments, the aqueous micro-ground cooked slurry is dried into a powder. The drying process chosen can be any of those known in the art including vacuum drying, drum drying, or spray drying. Preferably the particles are dried to a moisture content of 10% by weight or less, more preferably to a moisture content of less than 7% by weight. The dried powder can then be used in any desired food form to add insoluble fiber. These food forms include, by way of nonlimiting examples, beverages, ready to eat cereal, cereal products, cooked cereals, granola type products, health bars, confections, and baked goods of any sort.

In some embodiments, the cooked bran slurry is initially dried without processing through the aqueous micro-grinder. The cooked slurry can be dried by any of the processes known in the art including vacuum drying, drum drying, and spray drying. The cooked slurry is preferably dried to a moisture content of 10% by weight or less, more preferably to a moisture content of less than 7% by weight. Subsequently, the dried cooked bran slurry is subjected to grinding or pulverization to produce particles having a mean particle size of 150 microns or less, in some nonlimiting embodiments, 70 microns or less, and preferably 65 microns or less. The size-reduced cooked slurry powder is then able to be incorporated into a wide range of products, as described above, to add desired insoluble fiber to the product.

Some embodiments provide a bran product have reduced particle size and a soft texture due to the combination of a cooking step and a size reduction step. The product can be used directly in products or dried for later use. Unlike prior bran products, products in accordance with some embodiments have a pleasing texture with no grittiness or harshness.

The foregoing invention has been described in accordance with the relevant legal standards, thus the description is exemplary rather than limiting in nature. Variations and modifications to the disclosed embodiment may become apparent to those skilled in the art and do come within the scope of the invention. Accordingly, the scope of legal protection can only be determined by studying the following claims.

We claim:

1. A process for forming a modified bran product comprising the steps of:
cooking a bran at a temperature of from 250° to 290° Fahrenheit for a total time period of between 30 seconds and 4 minutes inclusive to form a cooked bran slurry; and
grinding the cooked bran slurry to a mean particle size of 150 microns or less.

2. The process of claim 1, further comprising the step of drying the cooked bran slurry after the grinding step.

3. The process of claim 1, wherein the mean particle size after the grinding step is 70 microns or less.

4. A food product comprising a modified bran product made according to the process of claim 1.

5. A food product according to claim 4, wherein the food product comprises a beverage, a cereal product, a granola-type product, a health bar, a confection, and/or a baked good.

6. A process for forming a modified bran product comprising the steps of:
cooking a bran at a temperature of from 250° to 290° Fahrenheit for a period of time of from 30 seconds to 4 minutes to form a cooked bran slurry;
drying the cooked bran slurry to a moisture content of 10% or less by weight; and
grinding or pulverizing the dried cooked bran slurry to a mean particle size of 150 microns.

7. The process of claim 6, wherein the mean particle size after the grinding or pulverizing step is 70 microns or less.

8. A food product comprising a modified bran product made according to the process of claim 6.

9. A food product according to claim 8, wherein the food product comprises a beverage, a cereal product, a granola-type product, a health bar, a confection, and/or a baked good.
